(19) United States
(12) Patent Application Publication
(10) Pub. No.: US 2018/0128407 A1
(43) Pub. Date: May 10, 2018

(54) CONNECTORS AND CONNECTOR ASSEMBLIES AND DEVICES AND INSTRUMENTS INCLUDING THEM

(71) Applicant: PERKINELMER HEALTH SCIENCES, INC., WALTHAM, MA (US)

(72) Inventor: Timothy Neal, Harwinton, CT (US)

(21) Appl. No.: 15/808,437

(22) Filed: Nov. 9, 2017

Related U.S. Application Data
(60) Provisional application No. 62/420,502, filed on Nov. 10, 2016.

(51) Int. Cl. F16L 37/252

(52) U.S. Cl. CPC F16L 37/252

(57) ABSTRACT

Certain configurations of connectors and connector assemblies are described herein. In some instances, the connector may comprise an internal locking member configured to rotate circumferentially between a first position to couple the connector to a component and a second position to release the connector from the component. If desired, the internal locking member may also provide for longitudinal movement to enhance a fluid tight seal.

### PRIORITY APPLICATION

This application is related to, and claims priority to and the benefit of, U.S. Provisional Application No. 62/420,502 filed on Nov. 10, 2016, the entire disclosure of which is hereby incorporated herein by reference for all purposes.

### TECHNOLOGICAL FIELD

This application is directed to connector assemblies and their use to connect fluid lines in chromatography systems. More particularly, certain configurations described herein are directed to a connector assembly which can provide a substantially fluid tight seal connection between two different chromatography fluid lines.

### BACKGROUND

Chromatography systems often include many different internal connections between components of the system. These connections typically include compression nuts which need to be tightened a suitable amount to avoid leaks. Leaks are common as temperature changes in the systems can cause contraction and expansion of the nuts and other connections.

### SUMMARY

Certain illustrative configurations of fluid connectors and their components are described in more detail below. While not every possible configuration of a connector is shown, the connectors can be used to couple fluid lines to each other, to couple a fluid line to a chromatography column or to couple other components where fluid such as, for example, a gas in one component can desirably be transferred to a separate component of the system.

In one aspect, a connector assembly configured to fluidically couple two or more separate fluid lines to each other is provided. In some examples, the connector assembly comprises a first body comprising an internal locking member configured to rotate circumferentially between a first position and a second position, the first body comprising a first end, a second end and a channel between the first end and the second end, the first end configured to fluidically couple to a first fluid line, and a second body configured to couple to the internal locking member of the first body, the second body comprising a first end and a second end opposite the first end, the second body comprising an internal channel between the first end and the second end, the internal channel of the second body configured to receive a second fluid line and retain a selected length of the second fluid line in a fixed position outside of the first end of the second body, wherein the internal locking member of the first body is configured to couple the first body to the second body in the first position of the internal locking member to retain the second fluid line within the channel of the first body and to fluidically couple the first fluid line to the second fluid line, in which the internal locking member is configured to provide a substantially fluid tight seal between the second body and the first body in the first position of the internal locking member.

In certain instances, the second body comprises an opening configured to expose a longitudinal section of the second fluid line when the second fluid line is inserted into the internal channel of the second body. In some examples, an outer diameter of the second body at the opening is larger than an outer diameter of the second body not at the opening. In other examples, the opening is sized and arranged to receive a removable retention device configured to engage the exposed section of the second fluid line in a first position of the retention device to retain the second fluid line in a fixed position within the second body.

In certain embodiments, the first body further comprises a first spring configured to provide a longitudinal force to the internal locking member to bias the internal locking member away from the first end of the first body in the second position of the internal locking member. In some examples, the internal locking member is configured as a locking collar that is configured to rotate circumferentially between the first position and the second position, in which the locking collar is further configured to move longitudinally toward the first end of the first body upon rotation from the second position to the first position. In other configurations, the first body further comprises a pair of internal locking balls positioned between the locking collar and the first end of the first body. In some instances, the pair of locking balls are configured to move radially outward when the locking collar is rotated circumferentially from the first position to the second position to permit insertion of the second body into the locking collar and are configured to move radially inward when the locking collar is rotated circumferentially from the second position to the first position to engage outer surfaces of the second body and retain the second body to the first body through an interference fit between the locking balls and the second body. In other instances, the locking collar is configured to rotate circumferentially to move the locking collar to a third position configured to provide a longitudinal force toward the first end of the first body to retain the second body to the first body and provide a substantially fluid tight seal between the second body and the first body.

In some examples, the third position of the locking collar is configured to provide the longitudinal force against a plurality of disc springs positioned between the locking collar and the first end of the first body, the plurality of disc springs configured to maintain the substantially fluid tight seal with temperature changes. In some embodiments, each of the disc springs comprises a nickel chromium alloy. In some examples, the first end of the second body is configured to receive a fitting sized and arranged to receive the second fluid line through an opening in the fitting.

In some configurations, the first body further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball within the first body. In some examples, the first body further comprises a retainer clip configured to couple to the second body and retain the first body to the second body prior to movement of the locking collar from the second position to the first position. In certain examples, the first body further comprises a rotator lever configured to couple to the locking collar. In other examples, the first body further comprises three rotating balls configured to facilitate rotation of the locking collar. In some instances, the first body further comprises a ball retainer ring configured to retain the rotating balls in the first body. In other instances, the first body further comprises a retainer clip configured to couple the rotator lever to the locking collar.

In certain examples, the first end of the second body is separable from the second end of the second body, and in which the first end of the second body comprises a material that can receive an axial force from the first body to retain the second body to the first body without any substantial deformation of the first end of the second body. In some examples, the first end of the second body comprises hardened steel or a nickel chromium alloy, and in which the internal locking member is configured to rotate circumferentially about ninety degrees from the second position to the first position.

In an additional aspect, a fluid line attachment device configured to fluidically couple a first fluid line to a second fluid line separate from the first fluid line is described. For example, the attachment device comprises a first end and a second end opposite the first end, the attachment device comprising an internal channel between the first end and the second end, the internal channel of the attachment device configured to receive the first fluid line and retain a selected length of the first fluid line in a fixed position outside of the first end of the attachment device, in which the attachment device comprises an opening configured to expose a longitudinal section of the first fluid line when the first fluid line is inserted into the internal channel of the attachment device, the opening configured to receive a retention device configured to engage the exposed section of the first fluid line in a first position of the retention device and disengage the exposed section of the first fluid line in a second position of the retention device.

In some configurations, the retention device is configured as an O-ring which slidingly engages the opening and the exposed section of the first fluid line in the first position of the retention device. In other instances, a body of the attachment device at the opening comprises a larger outer diameter than a body of the attachment device not at the opening.

In other instances, the retention device is configured as a leaf spring which engages the opening and the exposed section of the first fluid line in the first position of the retention device. In some examples, a body of the attachment device at the opening comprises a larger outer diameter than a body of the attachment device not at the opening.

In certain examples, the first end is configured to receive a fitting comprising an opening sized and arranged to receive the first fluid line. In other examples, the first end is configured to receive a ferrule comprising an internal opening configured to receive the first fluid line.

In some examples, the first end of the attachment device is separable from the second end of the attachment device. In other examples, the first end of the attachment device comprises a material that can withstand application of axial forces without substantial deformation. In certain embodiments, the first end comprises hardened steel or a nickel chromium alloy. In some examples, the second end comprises aluminum, hardened steel or a nickel chromium alloy.

In other configurations, the first end comprises about a same length as the selected length of the first fluid line in a fixed position outside of the first end.

In some configurations, the first end comprises a frustoconical shape configured to engage to a connector to provide a substantially fluid tight seal between the connector and the fluid line attachment device. In some examples, the first end comprises a fitting comprising the frustoconical shape. In some examples, the fitting is configured to deform when the fitting engages the connector.

In another aspect, a connector configured to fluidically couple two separate fluid lines is disclosed. In some examples, the connector comprises an internal locking member configured to rotate circumferentially between a first position and a second position, the connector comprising a first end, a second end and a channel between the first end and the second end, the first end configured to fluidically couple to a first fluid line, wherein the internal locking member is configured to couple the connector to a component comprising a second fluid line in the first position of the internal locking member to retain the component comprising second fluid line within the channel of the connector and to fluidically couple the first fluid line to the second fluid line, in which the internal locking member is configured to provide a substantially fluid tight seal between the component comprising the second fluid line and the connector in the first position of the internal locking member.

In certain embodiments, the connector further comprises a first spring configured to provide a longitudinal force to the internal locking member to bias the internal locking member away from the first end of the connector in the second position of the internal locking member. In some examples, the internal locking member is configured as a locking collar that is configured to rotate circumferentially between the first position and the second position, in which the locking collar is further configured to move longitudinally toward the first end of the connector rotation from the second position to the first position. In other examples, the connector further comprises a pair of internal locking balls positioned between the locking collar and the first end of the connector. In some instances, the pair of locking balls are configured to move radially outward when the locking collar is rotated circumferentially from the first position to the second position to permit insertion of the component comprising the second fluid line into the locking collar and are configured to move radially inward when the locking collar is rotated circumferentially from the second position to the first position to engage outer surfaces of the component comprising the second fluid line and retain the component to the connector through an interference fit between the locking balls and the component. In other examples, the locking collar is configured to rotate circumferentially to move the locking collar to a third position configured to provide a longitudinal force toward the first end of the connector to retain the component to the connector and provide a substantially fluid tight seal between the component and the connector. In some examples, the third position of the locking collar is configured to provide the longitudinal force against a plurality of disc springs positioned between the locking collar and the first end of the connector, the plurality of disc springs configured to maintain the substantially fluid tight seal with temperature changes. In other examples, each of the disc springs comprises a nickel chromium alloy.

In some configurations, the connector further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball. In certain instances, the connector further comprises a retainer clip configured to couple to the component and retain the connector to the component prior to movement of the locking collar from the second position to the first position. In some embodiments, the connector further comprises a rotator lever configured to couple to the locking collar. In certain examples, the connector further comprises three rotating balls configured to permit rotation of the locking collar. In some examples, the connector further comprises a ball retainer ring configured to retain the rotating ball in the connector. In certain instances, the connector further comprises a retainer clip configured to couple the rotator lever to the locking collar.

In some examples, the connector comprises threads at the first end.

In an additional aspect, an injector assembly comprises an injector inlet configured to receive a sample and provide at least some portion of the received sample to a separate fluid line, and a connector configured to couple to the injector inlet to fluidically couple the separate fluid line to the inlet of the injector, the connector comprising an internal locking member configured to rotate circumferentially between a first position and a second position, the connector comprising a first end, a second end and a channel between the first end and the second end, the first end configured to fluidically couple to the inlet of the injector and the second end configured to fluidically couple to the separate fluid line, in which the internal locking member of the connector is configured to couple the connector to a component comprising the separate fluid line in the first position of the internal locking member to retain the separate fluid line within the channel of the connector and to fluidically couple the separate fluid line to the injector inlet, in which the internal locking member is configured to provide a substantially fluid tight seal between the component comprising the separate fluid line and the connector in the first position of the internal locking member.

In certain examples, the connector further comprises a first spring configured to provide a longitudinal force to the internal locking member to bias the internal locking member away from the first end of the connector in the second position of the internal locking member. In some instances, the internal locking member is configured as a locking collar that is configured to rotate circumferentially between the first position and the second position, in which the locking collar is further configured to move longitudinally toward the first end of the connector upon rotation from the second position to the first position. In certain embodiments, the connector further comprises a pair of internal locking balls positioned between the locking collar and the first end of the connector. In certain examples, the pair of locking balls are configured to move radially outward when the locking collar is rotated circumferentially from the first position to the second position to permit insertion of the component comprising the separate fluid line into the locking collar and are configured to move radially inward when the locking collar is rotated circumferentially from the second position to the first position to engage outer surfaces of the component comprising the separate fluid line to retain the component comprising the separate fluid line to the connector through an interference fit between the pair of locking balls and the component. In some examples, the locking collar is configured to rotate circumferentially to move the locking collar to a third position configured to provide a longitudinal force toward the first end of the connector to retain the component comprising the separate fluid line to the connector and provide a substantially fluid tight seal between the component comprising the separate fluid line and the connector. In some examples, the third position of the locking collar is configured to provide the longitudinal force against a plurality of disc springs positioned between the locking collar and the first end of the connector, the plurality of disc springs configured to maintain the substantially fluid tight seal with temperature changes. In other examples, each of the disc springs comprises a nickel chromium alloy.

In certain embodiments, the connector further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball. In other embodiments, the connector further comprises a retainer clip configured to couple to the component comprising the separate fluid line and retain the connector to the component comprising the separate fluid line prior to movement of the locking collar from the second position to the first position. In some examples, the connector further comprises a rotator lever configured to couple to the locking collar. In additional examples, the connector further comprises at three rotating balls to permit rotation of the locking collar. In some embodiments, the connector further comprises a ball retainer ring configured to retain the rotating ball in the connector. In certain examples, the connector further comprises a retainer clip configured to couple the rotator lever to the locking collar. In other examples, the connector comprises threads at the first end to couple the inlet to the connector.

In another aspect, an injector comprising an inlet fluidically coupled to an integral connector is described. In some configurations, the injector inlet is configured to receive a sample and provide at least some portion of the received sample to a separate fluid line, the integral connector configured to fluidically couple to the separate fluid line, the integral connector comprising an internal locking member configured to provide an axial force in a first position and release the axial force upon movement of the locking member from the first position to a second position, the integral connector comprising a first end, a second end and a channel between the first end and the second end, the first end fluidically coupled to the inlet of the injector and the second end configured to fluidically couple to the separate fluid line, in which the internal locking member of the integral connector is configured to couple the connector to a component comprising the separate fluid line in the first position of the internal locking member to retain the separate fluid line within the channel of the integral connector and to fluidically couple the separate fluid line to the injector inlet, in which the internal locking member is configured to provide a substantially fluid tight seal between the component comprising the separate fluid line and the integral connector in the first position of the internal locking member.

In certain embodiments, the connector further comprises a first spring configured to provide a longitudinal force to the internal locking member to bias the internal locking member away from the first end of the connector in the second position of the internal locking member. In some examples, the internal locking member is configured as a locking collar that is configured to rotate circumferentially between the first position and the second position, in which the locking collar is further configured to move longitudinally toward the first end of the connector upon rotation from the second position to the first position. In other examples, the connector further comprises a pair of internal locking balls positioned between the locking collar and the first end of the connector. In some examples, the pair of locking balls are configured to move radially outward when the locking collar is rotated circumferentially from the first position to the second position to permit insertion of the component comprising the separate fluid line into the locking collar and are configured to move radially inward when the locking collar is rotated circumferentially from the second position to the first position to engage outer surfaces of the component comprising the separate fluid line to retain the component comprising the separate fluid line to the connector through an interference fit between the pair of locking balls and the component. In some instances, the locking collar is configured to rotate circumferentially to move the locking collar to a third position configured to provide a longitudinal force toward the first end of the connector to retain the component comprising the separate fluid line to the connector and provide a substantially fluid tight seal between the component comprising the separate fluid line and the connector. In other instances, the third position of the locking collar is configured to provide the longitudinal force against a plurality of disc springs positioned between the locking collar and the first end of the connector, the plurality of disc springs configured to maintain the substantially fluid tight seal with temperature changes.

In certain embodiments, each of the disc springs comprises a nickel chromium alloy.

In other embodiments, the connector further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball. In some instances, the connector further comprises a retainer clip configured to couple to the component comprising the separate fluid line and retain the connector to the component comprising the separate fluid line prior to movement of the locking collar from the second position to the first position. In certain examples, the connector further comprises a rotator lever configured to couple to the locking collar. In some embodiments, the connector further comprises three rotating balls configured to permit rotation of the locking collar. In certain examples, the connector further comprises a ball retainer ring configured to retain the rotating ball in the connector. In some examples, the connector further comprises a retainer clip configured to couple the rotator lever to the locking collar. In other examples, a first end of the connector comprises a smaller outer diameter than an outer diameter of the second end of the connector.

In an additional aspect, a detector comprises an inlet configured to receive a sample from a separate fluid line, the inlet fluidically coupled to a detection device, and a connector configured to couple to the inlet to fluidically couple the separate fluid line to the inlet of the detector, the connector comprising an internal locking member configured to rotate circumferentially between a first position and a second position, the connector comprising a first end, a second end and a channel between the first end and the second end, the first end configured to fluidically couple to the inlet and the second end configured to fluidically couple to the separate fluid line, in which the internal locking member of the connector is configured to couple the connector to a component comprising the separate fluid line in the first position of the internal locking member to retain the separate fluid line within the channel of the connector and to fluidically couple the separate fluid line to the detection device, in which the internal locking member is configured to provide a substantially fluid tight seal between the component comprising the separate fluid line and the connector in the first position of the internal locking member.

In certain embodiments, the connector further comprises a first spring configured to provide a longitudinal force to the internal locking member to bias the internal locking member away from the first end of the connector in the second position of the internal locking member. In other embodiments, the internal locking member is configured as a locking collar that is configured to rotate circumferentially between the first position and the second position, in which the locking collar is further configured to move longitudinally toward the first end of the connector upon rotation from the second position to the first position. In some examples, the connector further comprises a pair of internal locking balls positioned between the locking collar and the first end of the connector. In certain instances, the pair of locking balls are configured to move radially outward when the locking collar is rotated circumferentially from the first position to the second position to permit insertion of the component comprising the separate fluid line into the locking collar and are configured to move radially inward when the locking collar is rotated circumferentially from the second position to the first position to engage outer surfaces of the component comprising the separate fluid line to retain the component comprising the separate fluid line to the connector through an interference fit between the pair of locking balls and the component. In some examples, the locking collar is configured to rotate circumferentially to move the locking collar to a third position configured to provide a longitudinal force toward the first end of the connector to retain the component comprising the separate fluid line to the connector and provide a substantially fluid tight seal between the component comprising the separate fluid line and the connector. In other examples, the third position of the locking collar is configured to provide the longitudinal force against a plurality of disc springs positioned between the locking collar and the first end of the connector, the plurality of disc springs configured to maintain the substantially fluid tight seal with temperature changes. In some embodiments, each of the disc springs comprises a nickel chromium alloy.

In certain configurations, the connector further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball. In some examples, the connector further comprises a retainer clip configured to couple to the component comprising the separate fluid line and retain the connector to the component comprising the separate fluid line prior to movement of the locking collar from the second position to the first position. In certain examples, the connector further comprises a rotator lever configured to couple to the locking collar. In some examples, the connector further comprises three rotating balls configured to permit rotation of the locking collar. In certain embodiments, the connector further comprises a ball retainer ring configured to retain the rotating ball in the connector. In some examples, the connector further comprises a retainer clip configured to couple the rotator lever to the locking collar. In certain examples, the connector comprises threads at the first end to couple the inlet to the connector.

In another aspect, a detector comprises an inlet fluidically coupled to a detection device, the inlet comprising an integral connector configured to fluidically couple to a separate fluid line, the integral connector comprising an internal locking member configured to rotate circumferentially between a first position and a second position, the integral connector comprising a first end, a second end and a channel between the first end and the second end, the first end fluidically coupled to the inlet of the detection device and the second end configured to fluidically couple to the separate fluid line, in which the internal locking member of the integral connector is configured to couple the integral connector to a component comprising the separate fluid line in the first position of the internal locking member to retain the separate fluid line within the channel of the integral connector and to fluidically couple the separate fluid line to the detection device, in which the internal locking member is configured to provide a substantially fluid tight seal between the component comprising the separate fluid line and the integral connector in the first position of the internal locking member.

In certain examples, the connector further comprises a first spring configured to provide a longitudinal force to the internal locking member to bias the internal locking member away from the first end of the connector in the second position of the internal locking member. In some examples, the internal locking member is configured as a locking collar that is configured to rotate circumferentially between the first position and the second position, in which the locking collar is further configured to move longitudinally toward the first end of the connector upon rotation from the second position to the first position. In some embodiments, the connector further comprises a pair of internal locking balls positioned between the locking collar and the first end of the connector. In certain examples, the pair of locking balls are configured to move radially outward when the locking collar is rotated circumferentially from the first position to the second position to permit insertion of the component comprising the separate fluid line into the locking collar and are configured to move radially inward when the locking collar is rotated circumferentially from the second position to the first position to engage outer surfaces of the component comprising the separate fluid line to retain the component comprising the separate fluid line to the connector through an interference fit between the pair of locking balls and the component. In some examples, the locking collar is configured to rotate circumferentially to move the locking collar to a third position configured to provide a longitudinal force toward the first end of the connector to retain the component comprising the separate fluid line to the connector and provide a substantially fluid tight seal between the component comprising the separate fluid line and the connector. In some examples, the third position of the locking collar is configured to provide the longitudinal force against a plurality of disc springs positioned between the locking collar and the first end of the connector, the plurality of disc springs configured to maintain the substantially fluid tight seal with temperature changes.

In certain embodiments, each of the disc springs comprises a nickel chromium alloy.

In some examples, the connector further comprises a column lock housing, a lock ball cage configured to couple to the column lock housing, the lock ball cage configured to receive the pair of locking balls, and a spacer configured to couple to the lock ball cage and the locking collar, in which the spacer is further configured to spatially position at least one rotating ball. In some examples, the connector further comprises a retainer clip configured to couple the rotator lever to the locking collar.

Additional aspects, features, examples and embodiments are described in more detail below.

### BRIEF DESCRIPTION OF THE SEVERAL VIEWS OF THE DRAWINGS

Certain configurations of connectors are described below with reference to the accompanying figures in which:

FIG. 1A shows a body of a connector, in accordance with certain examples;

FIG. 1B shows a locking member of a connector, in accordance with certain embodiments;

FIG. 2A shows a connector comprising a body, locking member and a handle, in accordance with certain configurations;

FIG. 2B shows a locking member comprising a track configured to permit movement of one or more locking balls, in accordance with certain configurations;

FIG. 3 shows a connector comprising a body, a seal configured to fluidically coupled to the connector, a plurality of springs and a locking member, in accordance with certain instances;

FIG. 4 shows a component configured to couple to the connector, in accordance with certain examples;

FIGS. 5A, 5B and 5C show a second body or component which can couple to a connector, in accordance with certain examples;

FIG. 6 shows a fluid line within a first end of a component which can couple to a connector, in accordance with certain configurations;

FIGS. 7A and 7B show a retention device disengaged (FIG. 7A) and engaged (FIG. 7B) to an opening of a component which can couple to a connector, in accordance with certain examples;

FIG. 8A shows a disassembled view of a connector and FIG. 8B shows an assembled view of the connector of FIG. 8A, in accordance with certain embodiments;

FIG. 8C shows tabs and slots configured to couple the body to the handle, in accordance with certain configurations.

FIGS. 9A, 9B, 9C, 9D, 9E and 9F sequentially show coupling of a component comprising a fluid line to a connector, in accordance with certain configurations;

FIG. 10 is an illustration showing a connector comprising two ends each of which can couple to a second component comprising a fluid line, in accordance with certain examples;

FIG. 11 is an illustration showing a connector configured to couple an external fluid line to a device or instrument, in accordance with some configurations;

FIG. 12 is an illustration showing an injector coupled to a connector, in accordance with certain examples;

FIG. 13 is an illustration showing an injector with an integral detector, in accordance with certain embodiments;

FIG. 14 is an illustration showing a detector coupled to a connector, in accordance with certain examples;

FIGS. 15A and 15B are illustrations showing columns comprising connectors, in accordance with certain examples;

FIG. 16 is an illustration of a T-shaped connector comprising three connector sections, in accordance with certain examples; and

FIG. 17 is an illustration of a cross-shaped connector comprising three connector sections, in accordance with certain examples.

It will be recognized by the person of ordinary skill in the art, given the benefit of this disclosure, that the sizes and dimensions of the components are not necessarily shown to scale.

### DETAILED DESCRIPTION

Various components are described below in connection with connector assemblies which include two or more different components which can be coupled to each other and provide a substantially fluid tight connection which permits fluid from one component to flow to the other component. It will be recognized by the person of ordinary skill in the art, given the benefit of this disclosure, that other components can be included in the connectors or certain components or portions of a connector can be omitted while permitting the connector to still provide a substantially tight fluid connection. For ease of illustration and to facilitate a better understanding of the technology, not every component of a particular connector is shown or described.

In certain examples, the connectors described herein may comprise a first body which is configured to receive a second body or component and retain the second body or component to the first body for at least some period. The connector may comprise suitable internal features to provide sufficient forces, e.g., axial forces, to the second body or component and retain the second body or component to the connector. For example, the connector may comprise one or more internal features which can reversibly couple to the second body or component through an interference fit and generally deter or prevent removal of the second body or component from the connector until the forces which maintain the interference fit are released or removed. In some instances, the provided force may be a radially inward force which acts to retain the second body within the connector. In other configurations, the connector may also provide a longitudinal force, in addition to the inward radial force or in place of the inward radial force, to retain the second body or component to the connector. These forces act, at least in part, to couple the second body or component to the connector and provide a fluid tight seal between the connector and the second body or other component. In some instances, the connector can be configured to permit a user to couple the second body or component to the connector without the use of any tools, without using any external fasteners, or in certain configurations even with one hand.

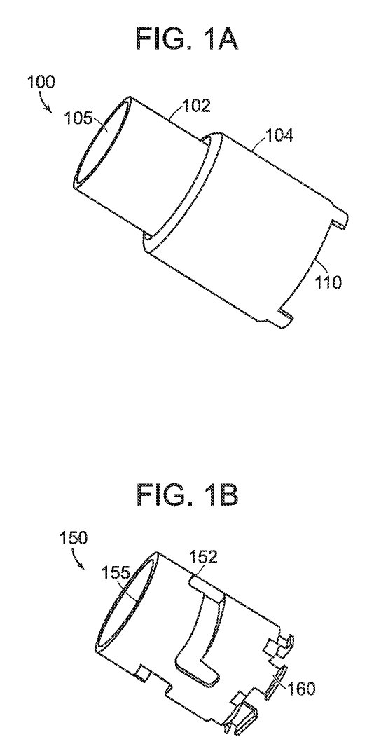

In some configurations and referring to FIG. 1A, a body of a connector 100 is shown that comprises a first section 102 with a smaller outer diameter than an outer diameter of a second section 104. If desired, however, the connector 100 may be generally cylindrical in shape with a substantially constant outer diameter. An inner section of the connector is configured to receive an internal locking member 150 (see FIG. 1B) or comprises an integral internal locking member. The locking member 150 may be sized and arranged to insert into the inner section (to at least some degree) and can be retained within the connector 100. In some instances, the locking member 150 is configured as a locking barrel which can receive a portion of a second body or component and may be circumferentially rotated from one position to another to permit the connector 100 to retain the second body or component. For example, the second component can be inserted into the bottom 160 of the locking member 150 in an upward direction toward the top 155 of the locking member 150. One or more features present in the connector body 152 can be configured to contact outer surfaces of the second body or component to lock the second body or component to the connector. In some instances, the locking member 150 may comprise locking balls or other features which can act to provide an axial force, e.g., an inward axial force, to the second body or component upon circumferential rotation of the locking member 150 within the connector 100. This axial force may move the locking balls or other features into position to engage the component through an interference fit. For example, a user can insert a second component into the bottom surface 160 of the locking member 150 until a top portion of the second component engages the connector 100, e.g., the second component can be inserted until it encounters resistance from the connector 100. In some instances, the second component is inserted into the connector 100 until it engages a lower surface of the narrower portion 102 of the connector 100. A user can then grasp a lower portion of the locking member 150 which can protrude from the bottom surface 110 of the connector 100. The locking member 150 can then be rotated circumferentially to permit internal features of the connector 100 to apply an axially inward force (e.g., from one or more locking balls) against the outer surface of the second component and optionally to cause movement of the second component longitudinally toward a top surface 105 of the connector 100. The locking member 150 can be sized and arranged such that circumferential rotation of the locking member 150 from an initial, unlocked position to a locked position causes some portion of the connector 100, e.g., the locking balls, to come into contact with outer surfaces of the second body or component. For example, one or more pairs of locking balls can contact some portion of the outer surfaces of the second body or component to provide an interference coupling between the locking balls and the second component as the locking balls apply an axial force to the second component. The interference coupling or interference fit generally acts to prevent removal of the second component until the axial force from the locking balls is released, e.g., until the locking member 150 is rotated circumferentially back to its initial, unlocked position. The axial force is desirably large enough to retain the second component but not so large that the walls or body of the second component will deform to a substantial degree under the axial forces. Where longitudinal movement is also provided by rotation of the locking member 150, this longitudinal movement can act to bias the second component upward toward the top surface 105 of the connector 100 and enhance the substantially fluid tight seal between the connector 100 and the second component. Where the second component comprises a fluid path, column or other devices which can receive a fluid such as a gas, coupling of the second component to the connector 100 provides a substantially fluid tight seal between the connector 100 and the fluid path, column or other device. The top surface of the connector 100 may couple to a first fluid path (not shown) so that the first fluid path and the fluid path, column or device of the second component are fluidically coupled in a substantially fluid tight manner, e.g., so that no leaks are present and so fluid can be provided from the first fluid path to the fluid path, column or device. Circumferential rotation of the connector in an opposite direction from the locked position can release the axial force to remove the interference fit and permit decoupling of the second component from the connector. As noted herein, the coupling of the component to the connector 100 can be performed by a user with only a single hand if desired.

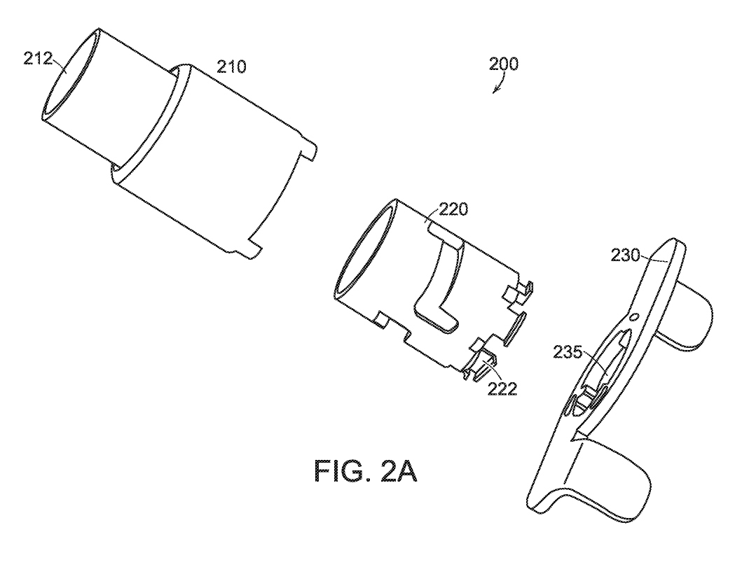

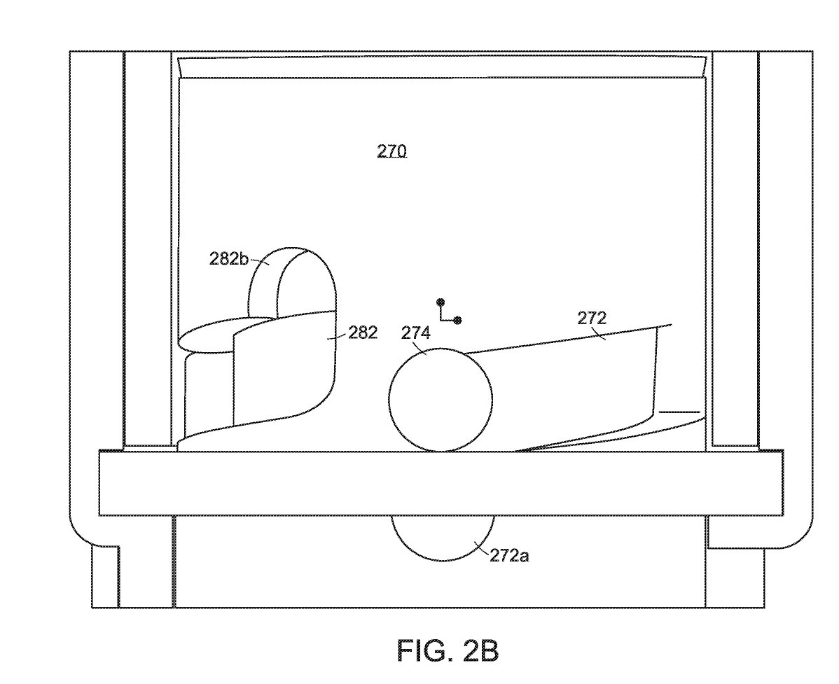

In certain instances, the connectors described herein may comprise a lever, handle or other component configured to couple to a locking member to facilitate circumferential rotation of the locking member. For example and referring to FIG. 2A, a connector 200 comprises a first body 210 which is configured to receive a locking member 220. A handle 230 is configured to couple to the locking member 220. For example, the locking member 220 can engage the handle 230 through teeth, threads, fingers or other projections at the end 222 of the locking member 220. In some instances, the end 222 of the locking member 220 can be inserted into the handle 230 through the bottom and locks into place be engaging a receptive feature such as a groove or threads present on or in the handle 230. Notwithstanding that the locking member 220 can couple to the handle 230 in numerous manners, the locking member 220 and handle 230 are coupled to each other in a suitable manner such that the handle 230 and the locking member 220 generally rotate circumferentially together. The larger grasping surface of the handle 230 permits easier rotation of the locking member 220 than when the handle 230 is absent. For example, the connector 200 can be used similar to the connector 100 except the user can grasp the handle 230 directly rather than the locking member 220. In use, a second component (not shown) is inserted through the opening 235 in the handle 230 and upward toward a top surface 212 of the body 210. After the second component is inserted to a suitable degree, the handle 230 and locking member 220 are rotated circumferentially, e.g., by 30, 45 degrees, 60 degrees, 75 degrees, 90 degree or more, to couple the second component to the body 210. In some instances, rotation of the locking member 220 can also bias the second component toward the top surface 212 of the body 210 by applying a longitudinal force or otherwise pushing the second component toward the top surface 212. In some configurations, initial circumferential rotation of the locking member 220 by a certain number of degrees, e.g., 75 or 90 degrees, provides an axial force, e.g., from one or more locking balls, and further rotation, e.g., by an additional 30, 60, or 90 degrees, acts to apply the longitudinal force to bias the second component toward a top surface 212 of the body 200. While not shown, the handle 230 may comprise a locking pin or feature which can be engaged once rotation is complete to prevent the handle from inadvertently rotating in an opposite direction. In some instances as shown in FIG. 2B (where the connector is shown in the locked position), a locking member 270 may comprise a first helical track 272 (or multiple, separate helical tracks) which can guide one or more rotating balls such as rotating ball 274 between different positions. For example, the rotating ball 274 can be present in the track 272 at a first position 272a and be forced to a second position at an opposite end of the track 272. The ball 274 can drop into a detent to retain the ball in place and lock the connector in the locked position. This opposite end is shown in a second helical track 282 as position 282b. Movement of the balls 274 between the different positions can act to limit the overall degrees which the locking member can rotate. As discussed in more detail below, when the connectors experience different temperatures, certain component may expand and alter the size and/or geometry of some components of the connector. To prevent inadvertent rotation with changes in temperature, the locking feature of the handle can be placed into a locked position to fix the handle at a selected position. The locking feature can also deter or prevent further rotation in a locking direction to reduce the application of additional force to the second component.

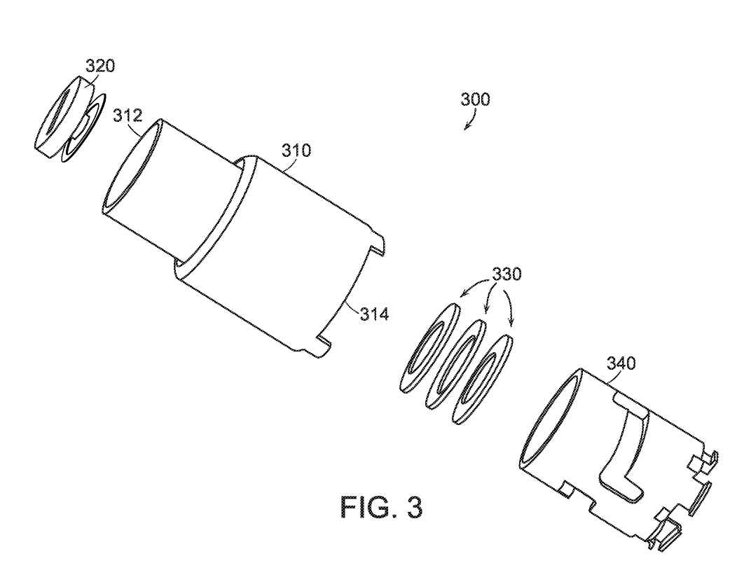

In certain configurations and referring to FIG. 3, a connector 300 comprises a body 310 configured to couple to a seal 320. The body 310 is also configured to receive one or more springs 330 and a locking member 340. The seal 320 generally engages the body 310 at a top surface 312 between the body 310 and another component, e.g., an injector, fluid line, manifold, etc. The springs 330 insert into an inner portion of the body 310 from the bottom surface 314. The springs 330 can be configured to provide a biasing force downward to the locking member 340 when the locking member 340 is inserted into the body 310. For example, in a non-locking state of the connector 300, the locking member 340 is generally biased away from a top surface 312. In a locking state after rotation of the locking member 340, the springs 330 can act to bias the second body or component (not shown) up against the seal 320 to enhance the substantially fluid tight seal. In some instances, the materials of the springs 330 can be selected so that they provide a substantially constant force to the locking member 340 over a desired temperature range. As noted herein, some components present in a connector or component coupled to the connector can expand or contract with changes in temperature. For many existing connectors, e.g., those which use compression nuts, etc., these changes in temperature can result in fluid leaks at the connection. By including the springs 330, the forces applied by the connector 300 can act to maintain the substantially fluid tight seal even over a broad temperature range of about −200 degrees Celsius to about +600 degrees Celsius, for example.

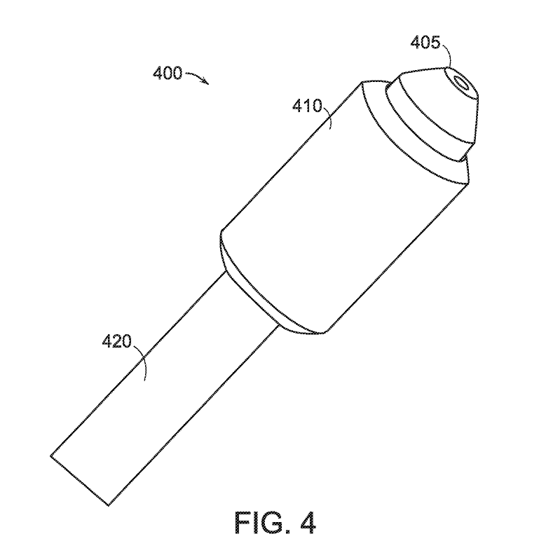

In certain examples, a component to be coupled to the connector can be sized and arranged to insert into the connector (at least to some extent) to permit the internal locking member of the connector to couple the connector to the component. One illustration of a component is shown in FIG. 4. The component 400 comprises a first end 410 and a second end 420. While an outer diameter of the second end 420 is shown as being less than an outer diameter of the first end 410, the diameter of the second end 420 can be the same or larger than an outer diameter of the first end 410 if desired. While not shown in FIG. 4, the component 400 comprises an inner channel which traverses the entire length of the component 400 from the first end 410 to the second end 420. This channel is designed to receive a fluid line, column or other device which has a fluid path. Coupling of the component 400 to a connector provides fluidic coupling between the fluid path present in the component 400 and a separate fluidic device coupled to the connector. The first end 410 comprises an outer diameter that is sized and arranged to insert into the interior of the connector. The exact fit between the outer surface of the end 410 and the locking member of the connector will vary. The end 410 need not sit flush against the surfaces of the locking member prior to rotation of the locking member to provide the axial forces to the component 400. Once the locking member is rotated, axial forces from the connector, e.g., the locking balls, are generally against the end 410 and optionally to the end 420 to retain the component 400 to the connector through an interference fit. The provided forces need not be provided to all areas of either of the ends 410, 420. As discussed herein, it is sufficient that some features of the connector contact some portion of the end 410 to retain the component 400 to the connector.

In the configuration shown in FIG. 4, the first end 410 comprises a frustoconical shape at the top of the end 410. This shape may be integral to the first end 410 or another component or device can be coupled to the first end 410 to provide this frustoconical shape at the first end 410 of the component 400. For example, in some instances, the first end 410 and the second end 420 may comprise the same material and may be integral. In other configurations, the first end 410 may be a separable component from the second end 420, and the second end 420 can even be omitted if desired. If desired, the first end may comprise a material that can withstand the axial forces provided by the connector, whereas the second end can be the same as the first end or may comprise a softer or more flexible material if desired. Notwithstanding that many different types of materials such as aluminum, steel, hardened steel, titanium, nickel chromium alloys, etc. can be used for the ends 410, 420, the materials selected desirably transfer heat to any fluid path, column or other device within the inner channel of the component 400 to permit heat to be provided to any fluid within the component 400. In certain configurations, a tip 405 of the end 410 may be a separate component from the end 410 and may be placed into the end 410, engaged to the end 410 through threads or other coupling features or may otherwise be coupled to the end 410 to provide the frustoconical shape to the end 410. The frustoconical shape is not necessarily required and other shapes including curved shapes, trapezoidal shapes, triangular shapes or even rectangular shapes may be present instead at the tip 405 of the component 400. The fluid line, column or other device may protrude from the tip 405 or may remain with the internal channel of the component 400 if desired.

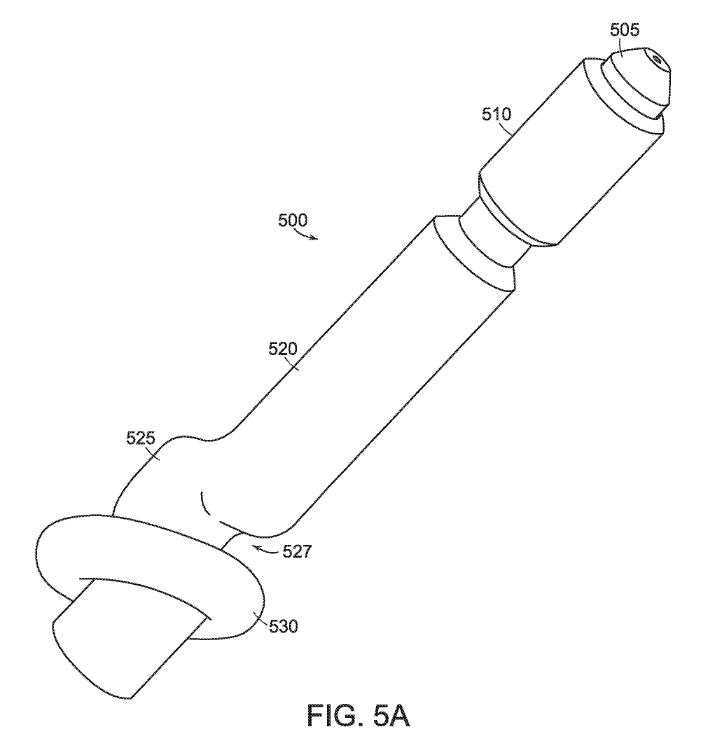

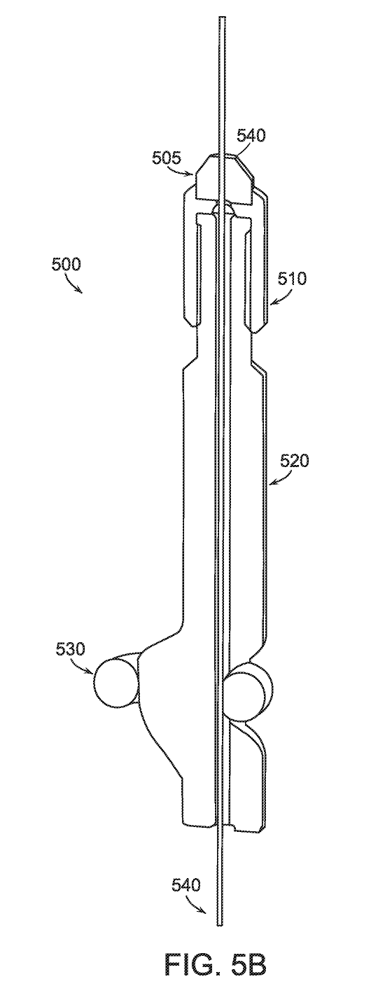

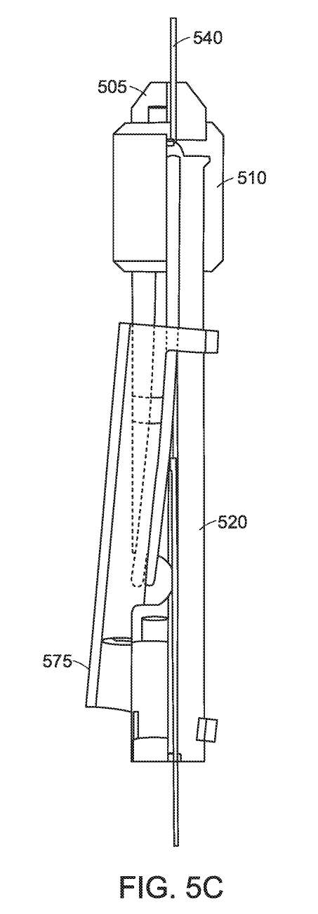

In certain examples, the component to be coupled to the connector may comprise one or more features to facilitate coupling of the fluid line, column or other fluidic device to the component itself. Referring to FIG. 5A, a second body 500 is shown that comprises a first end 510 comprising a tip 505 and a second end 520 comprising an optional bump out or protrusion 525. Where a protrusion 525 is present, the protrusion 525 exposes a longitudinal portion of the internal channel of the body 500 to permit an O-ring 530 (or other device) to engage a fluid line, column or other fluidic device inserted into the internal channel of the body 500. For example, the O-ring 530 can be moved upward toward the tip 505 so it engages the space 527 formed by the protrusion 525 (see FIG. 5B showing a column 540 within the body 500). Engagement of the O-ring to the fluid path, column or fluidic device can hold the path, column or device in place until the body 500 is coupled to the connector. The forces from the connector can act to compress the tip 505 to some degree. In other instances, the tip 505 may comprise a suitable opening that is sized and arranged to receive the fluid path, column or fluidic device. Insertion of the body 500 into a connector can result in the application of the axial forces to the body 500 and provide the fluidic coupling between the fluid path, column or fluidic device and other fluid path (not shown) coupled to the connector (also not shown). Referring to FIG. 5C, a similar design to the component or second body of FIG. 5A is shown where the O-ring has been replaced with a device 575, e.g., a device which can force a spring against the fluid line and then lock after the force is applied, can provide a force against the fluid line in a first position and release the force in a second position For example, a user can hold the second body 500 between the thumb and forefinger while inserting the column 540 (or a fluid line). When the column 540 is at the correct gage length, the user can then compress the device 575 and slide it down the second end 520 away from the tip 505. Engagement of the column 540 by the device 575 in a first position of the 575 can act to retain the column 540 in a fixed position in the second body 500.

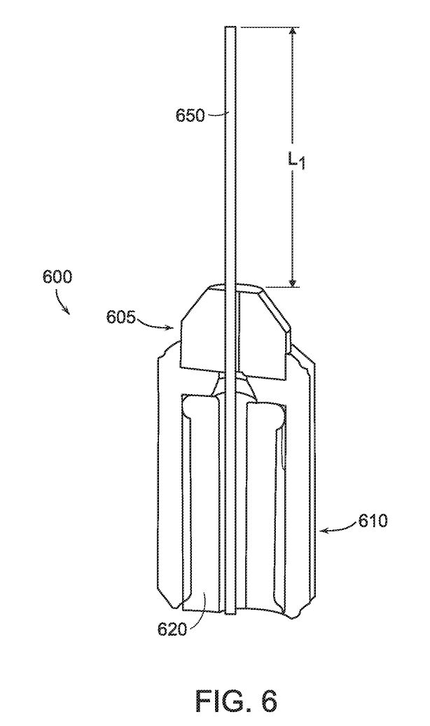

Referring now to FIG. 6, the second body can be sized and arranged to permit a user to select a certain length L₁ of a fluid line 650 which protrudes from the tip 605 of the second body 600. In some instances, the overall length of the first end 610 of the second body 600 may be sized to be about the same length as a desired protrusion length for the fluid path, column or other device. In other configurations, the first end 610 may comprise markings or indicia on it to permit a user to estimate the length of the fluid path, column or fluidic device extending from the tip 605 of the second body 600. In some embodiments, a user can measure the length of the fluid path, column or fluidic device extending from the tip 605 using an external device such as a ruler or gauge. In some instances, a template or guide can couple to the second body 600 and extend above the body 600 for a certain length L₁. A user can insert the fluid path, column or other fluidic device into the internal channel of the body 600 and keep inserting until the path, column or device engages a bottom surface of the template or guide positioned above the tip 605 of the body 600. Once an end of the path, column or device hits a bottom surface of the guide, the guide can be removed and the second body and inserted path, column or device can be coupled to a connector as described herein. FIG. 6 also shows how a portion of a second end 620 can extend into the first end 610 to couple the first end 610 to the second end 620 of the component 600 to be coupled to a connector.

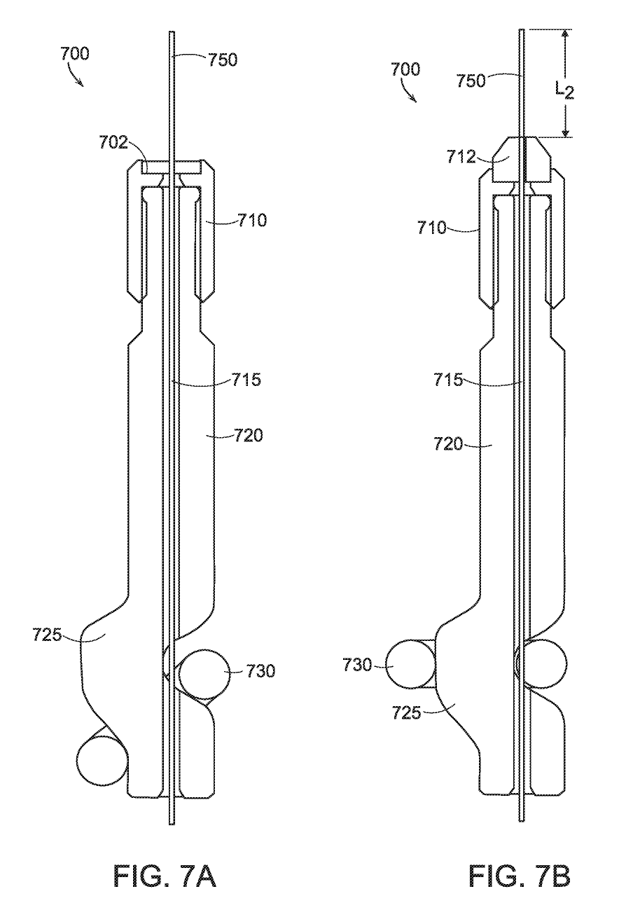

In certain embodiments and referring to FIGS. 7A and 7B, a second body 700 is shown in FIG. 7A as comprising a first end 710 and a second end 720 comprising a protrusion 725 which can receive an O-ring 730, leaf spring, etc. as described herein. A fluid line 750 is shown as being inserted into the body 700 through an internal channel 715 which traverses the entire length of the body 700. The first end 710 comprises a generally flat top surface 702 which can receive a ferrule or other fitting 712 (see FIG. 7B). The fitting 712 can act to receive the fluid line 750 and may be compressed to some extent when the body 700 is coupled to a connector (not shown). In the position of FIG. 7A, the fluid line 750 can be inserted from a first end 710 or the second end 720 and positioned in a suitable manner. The O-ring 730 is then moved upward (as shown in FIG. 7B), which stretches the O-ring 730 and places it against an outside surface of the fluid line 750. The fitting 712 may then be slid or placed on top of the protruding portion of the fluid line 750 and engage the top surface 702 of the first end 710. In some instances when the body 700 is coupled to a connector, the fitting 712 can compress or deform to some extent to enhance a fluid tight seal between the body 700 and the connector. For example, as the locking member of the connector is rotated circumferentially, axial forces are exerted by the connector against the end 710 and optionally against the end 720. The axial forces can retain the body 700 to the connector, for example, through an interference fit. In a typical operation where the fluid line 750 is coupled to a connector, a portion of the fluid line protruding through the first end 710 is typically removed to remove any contamination which may have occurred during insertion of the fluid line 750 into the body 700. The protruding length of the fluid line is then selected to be a length L₂ and the body 700 and fluid line 750 assembly is then coupled to a connector. Once the body 700 and fluid line 750 assembly are coupled to a connector, the O-ring 730 may remain in place or it may be removed as desired.

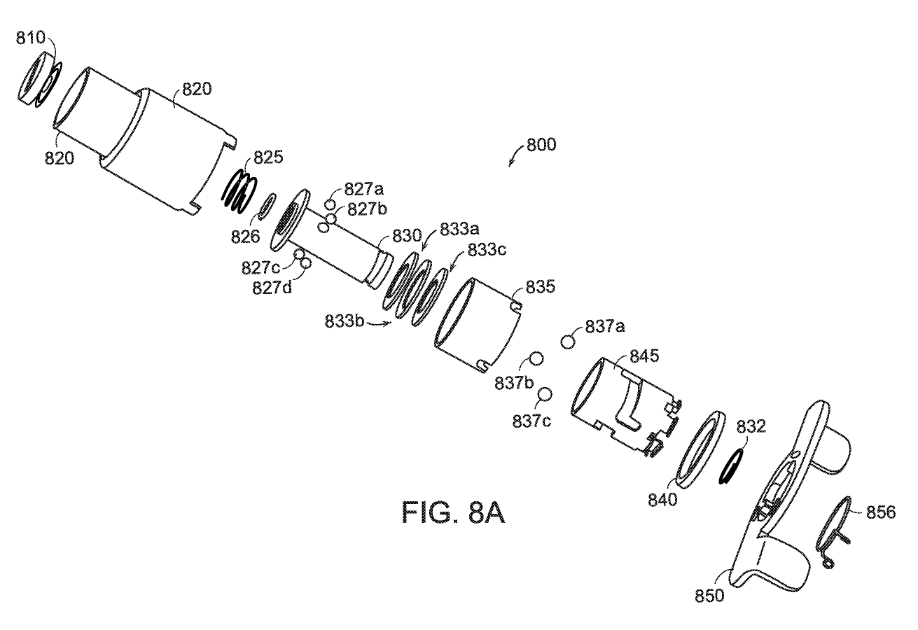

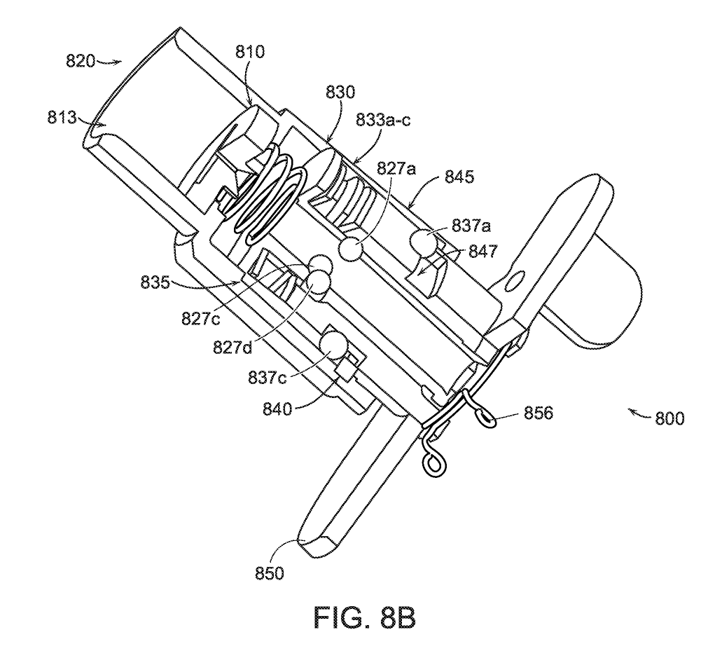

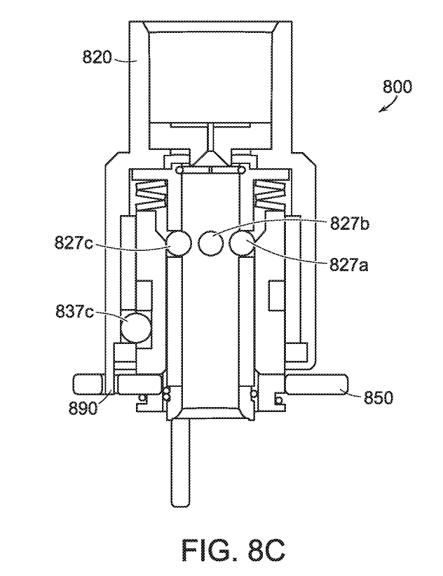

In certain configurations and referring to FIG. 8A, a disassembled view of another configuration of a connector 800 is shown. The connector 800 comprises an inlet seal 810, a main body 820, a spring 825, a retainer clip 826, a lock ball cage 830, lock balls 827a, 827b, 827c and 827d, a retainer clip 832, disc springs 833a, 833b, 833c, a spacer 835, rotating balls 837a, 837b, 837c, a ball retainer ring 840, a locking member 845 and a lever 850 which can rotate the locking member 845 as described herein. A cross section of an assembled view of the components of the connector 800 is shown in FIG. 8B.

To assemble the connector 800, the disc springs 833a, 833b, 833c are preassembled to the to lock ball cage 830, install lock balls 827a-827d into lock ball cage 830, place locking member 845 onto lock ball cage 830. Retainer clip is installed to keep subassembly together. Retainer clip 826 is inserted into lock ball cage 830. The liner seal 810 can be placed on top of the main body 820 or it can be omitted. The spring 825 is inserted into the bottom of the body 820 followed by inserting the subassembly mentioned above. The ball spacer 835 is the inserted from the bottom of the body 820 followed by the rotator balls 837a, 837b, and 837c. The ball retainer ring 840 is then inserted and the bottom of main body 820 is formed over ball retainer ring 840 to retain the entire assembly. Some portion of the locking member 845 will protrude from the bottom surface of the body 820 and the handle 850 can be engaged to the locking member 845 and secured by retainer clip 856.

As shown in FIG. 8B, the locking member 845 comprises a helical ball track 847. The helical ball track 847 in combination with the balls 837a, 837b and 837c provide a low resistance to assist in locking the second body (not shown) to the connector 800. The components within the connector 800 may be retained, for example, by crimping the end of the body 820 to hold the components within the connector, or the handle 850 or other components may be threaded into the connector 800 to retain the internal components of the connector 800 in place. As shown in FIG. 8C, one or more tabs, such as tab 890 can engage a slot of the handle 850 to lock the handle 850 and body 820 together so they rotate together in the same direction. One, two, three or more tabs can be present in the body 820 with a corresponding slot(s) on the handle 850. Alternatively, one, two or three tabs can be present in the handle 850 with a corresponding slot(s) on the body 820.

In certain examples, the exact configuration of the lock balls and the rotator balls may vary. In some instances, each of the lock balls 827a-d and the rotator balls 837a-c may comprise hardened steel or other components. In some examples, the lock balls 827a-827d may comprise hardened steel which can engage a hardened steel first end of a component to be coupled to the connector 800, e.g., an interference fit between the lock balls 827a-827d and the first end of the component to be coupled to the connector 800 may result. For example, the lock balls 827a-d may comprise 1-3 mm diameter steel balls. The number of lock balls is not critical, and in certain instances, two, three, four, five or more lock balls may be present in the connector. With reference to the rotating balls 837a-837c, these balls may comprise 1-3 mm diameter balls as well, and there may be two, three, four, five or more rotating balls as desired. The body 820 may comprise threads 813 or other features which can couple to a separate fluid line or fluidic device (not shown). For example, the threads may be configured to couple the body 820 to an injector, a detector, a manifold or other devices which can provide or receive a fluid. As noted herein, the disc springs 833a-833c typically comprise a high temperature material that can provide suitable forces to retain the fluid tight seal between the connector 800 and a second component over a wide temperature range. Illustrative materials include, but are not limited to, titanium, alumina, nickel chromium alloys such as Inconel® alloys and other high temperature materials. The locking member 845 may take many different configurations such as a collar or other device which can receive a second body to be coupled to the connector 800.

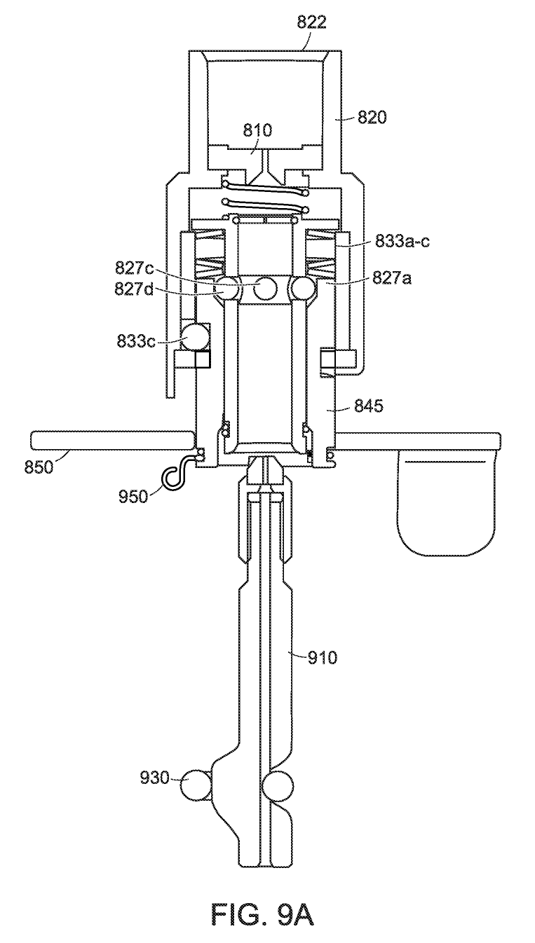

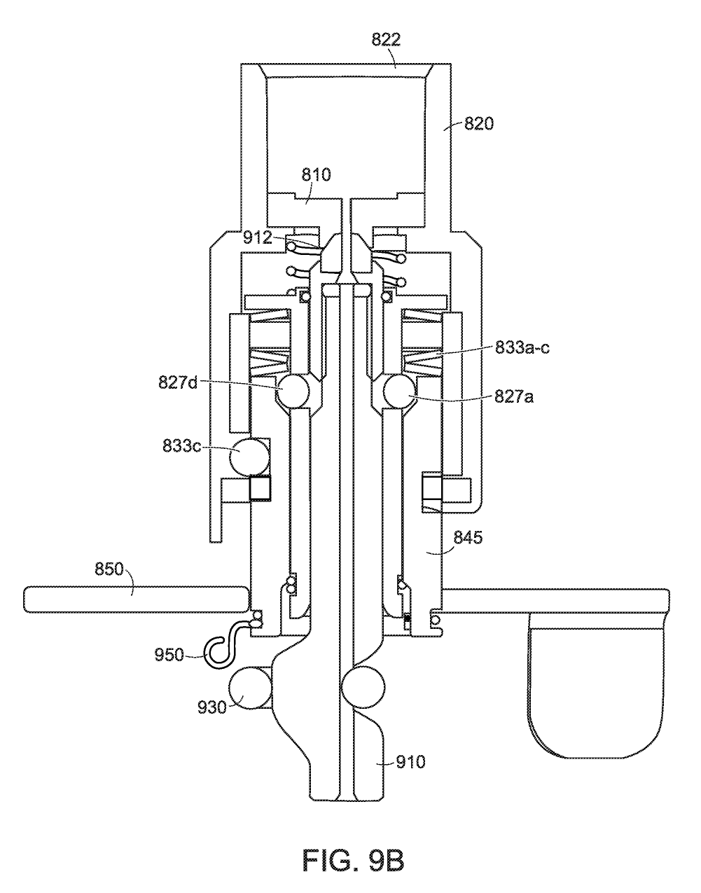

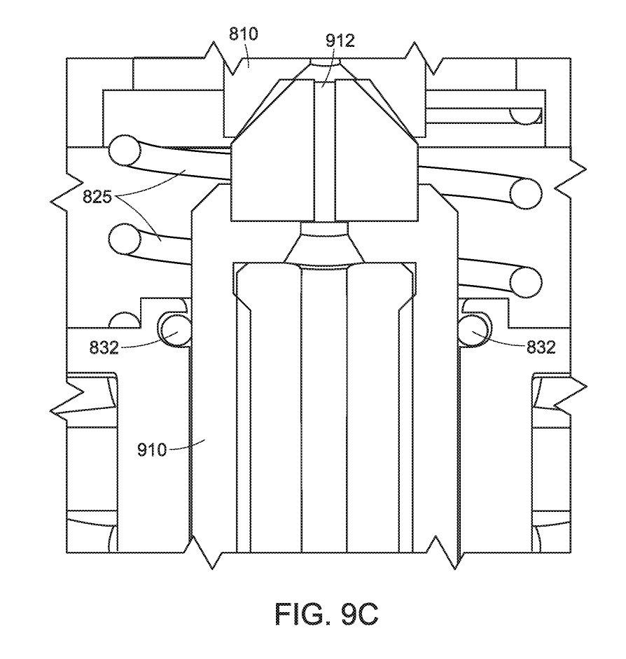

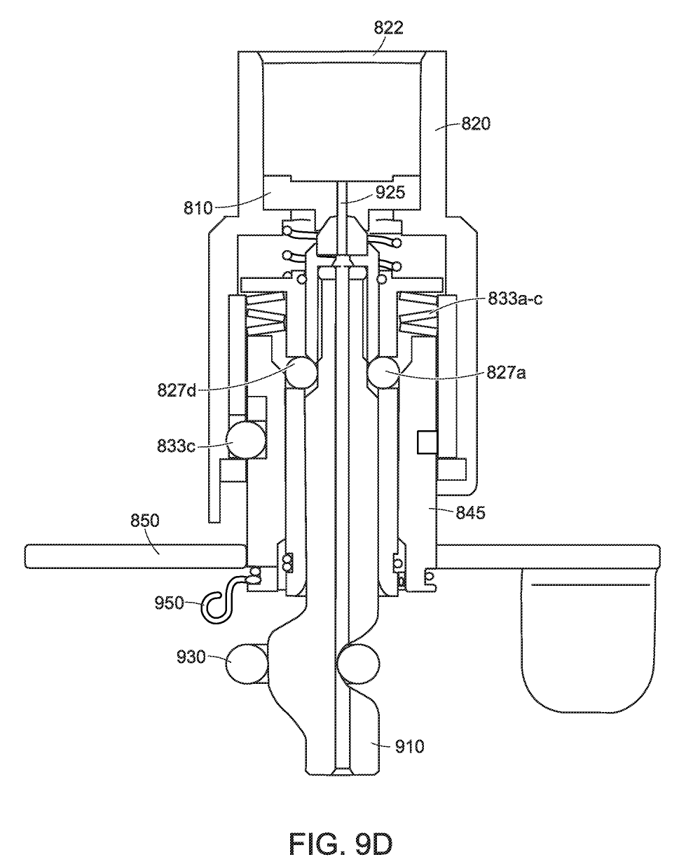

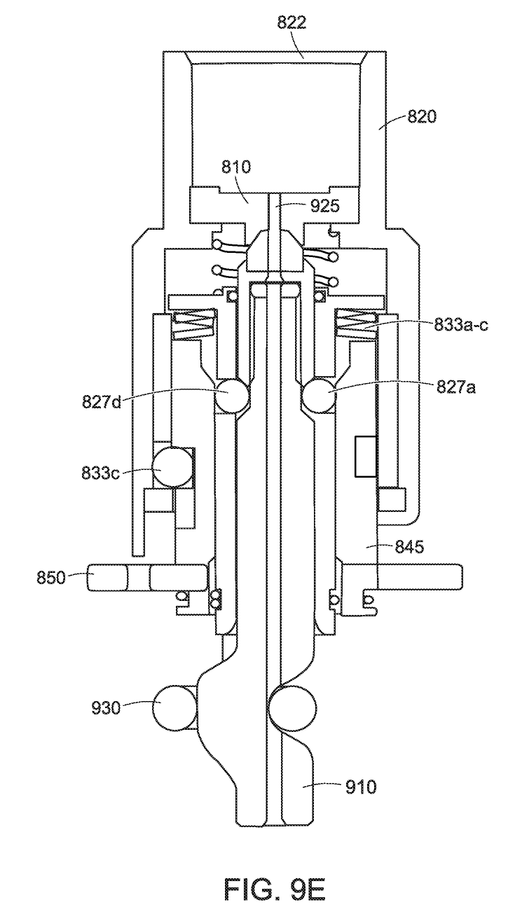

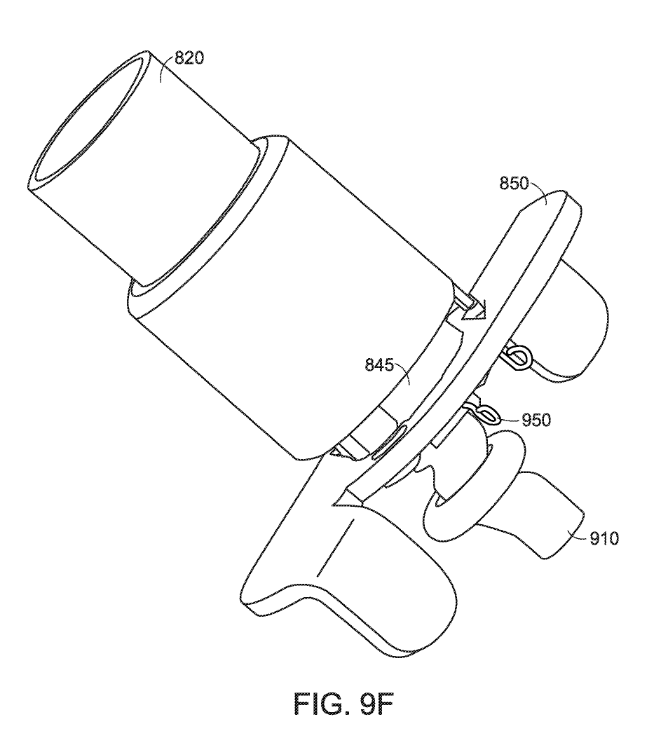

In certain embodiments, FIGS. 9A-9F sequentially show how the connector 800 of FIGS. 8A and 8B can be used to couple to a second body 910. Referring to FIG. 9A, in an open position, the locking member 845 of the connector 800 is in a downward most position away from the opening of the body 820. The balls 827a, 827c and 827d are positioned radially outward toward the inner surfaces of the body 820 to permit the second body 910 to be inserted into the interior of the connector 800. The body 910 is inserted into the connector 800, in an upward manner, until a tip 912 (see FIG. 9C) of the body 910 contacts the seal 810 (see FIG. 9B). Resistance is met when the tip 912 engages a lower surface of the seal 810. The balls 827a, 827d do not yet engage the surfaces of the body 910 to any substantial degree (see position of lock balls 827a, 827d in FIG. 9B). As shown in FIG. 9C, the retainer clip 832 acts to retain the body 910 to the connector 800 after the body 910 is inserted but before the locking member is rotated. This feature of the retainer clip 832 permits a user to insert the body 910 into the connector 800 using a single hand. The ability to couple the components 800, 910 with a single hand is a particularly desirable attribute, since conventional couplers tend to require at least two hands to tighten couple the components and tighten them together.

Referring now to FIG. 9D, the locking member 845 is moved upward toward the top 822 of the body 820 by rotating the handle 850 circumferentially. This rotation causes the balls 827a, 827d to move radially inward and engage the outer surfaces of the body 910 through an interference fit, e.g., the balls 827a, 827d may slide under protrusions in the body 910 to lock the body 910 to the connector 800, and provide a substantially fluid tight seal between the top of the body 910 and the connector 800. The axial force applied by the balls 827a, 827d is desirably great enough to maintain the substantially fluid tight seal but not so great that deformation of the body 910 will occur. Rotation of the locking member can continue a desired number of degrees, e.g., 15-180 degrees, which causes the locking member 845 to move upward toward the top 822 of the body 820. This upward movement results in compression of the disc springs 833a-833c and sealing of the top of the body 910 to the liner seal 810. In instances where a ferrule or fitting is present at the top of the body 910, the ferrule or fitting may be compressed or deformed, at least to some degree, by movement of the locking member 845 upward. If desired, the handle 850 may comprise a retaining clip 950 (see FIG. 9D) which can be used to couple the handle 850 the locking member 845 so these two components generally move in the same circumferential direction upon circumferential rotation. When the components are finally coupled, a tip of a fluid line 925 (see FIG. 9E) can be flush with the connector 800 to permit fluid to flow from a component coupled to the body 810 and into the fluid line 925. A perspective view of the coupled components is shown in FIG. 9F.

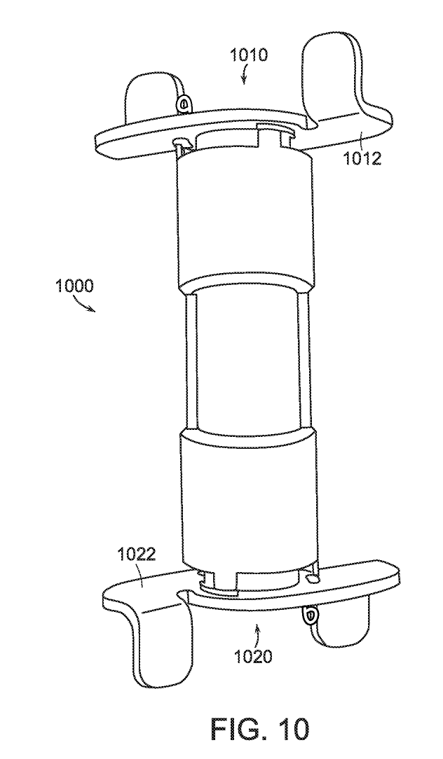

In certain instances, the connectors described herein can be used to fluidically couple two separate fluid lines to each other. Referring to FIG. 10, a connector 1000 is shown that comprises a first section 1010 and a second section 1020. The first section 1010 is configured to couple to a component similar to that shown in FIGS. 7A and 7B. Similarly, the second section 1020 is configured to couple to a component similar to that shown in FIGS. 7A and 7B. Each of the components which couple to each end of the connector 1000 may comprise an internal fluid line. By coupling of the different components to each section 1010, 1020 of the connector 1000, fluid can be provided from one fluid line to the other through the connector 1000. Each component can be coupled to the connector 1000 using a single hand if desired to facilitate rapid coupling of two separate fluid lines within a device or instrument. In use of the connector 1000, a first component comprising a first fluid line can be inserted into the end of the section 1010 until the component encounters resistance. The rotating lever 1012 may then be rotated circumferentially to lock the internal locking member of the section 1010 of the connector 1000 to the inserted component. A different component comprising a second fluid line can be inserted into the end of the section 1020 until the different component encounters resistance. The rotating lever 1022 may then be rotated circumferentially to lock the connector 1000 to the inserted different component. Once the components are locked to the connector 1000 fluid flow from the first fluid line to the second fluid line is permissible through the connector 1000.

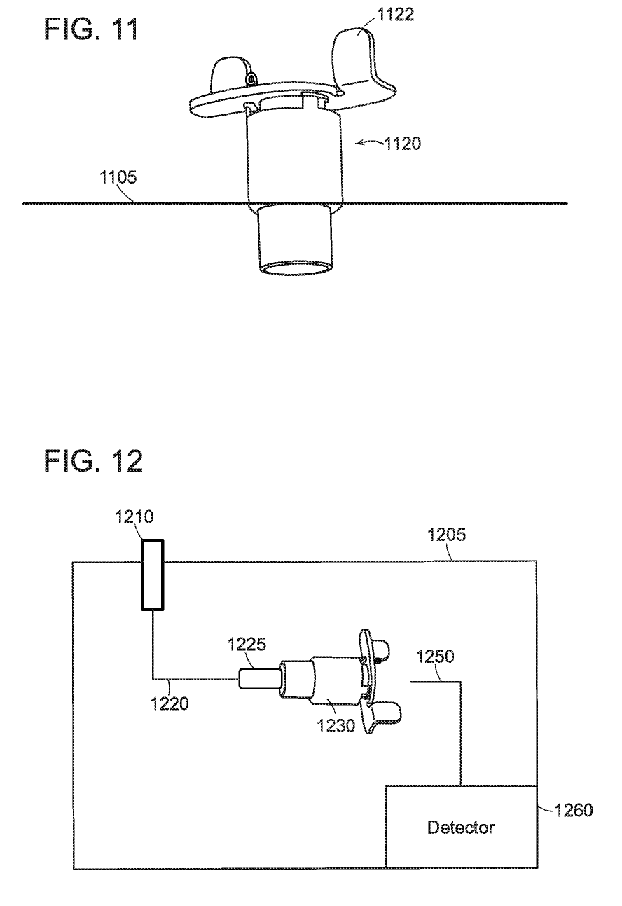

In other configurations, the connectors described herein may be present on a surface of a device or instrument to facilitate fluidic coupling of an external fluid line to one or more internal fluid paths within the device or instrument. Referring to FIG. 11, a surface 1105 of a device or instrument is shown comprising an integral connector 1120. A second end of the connector 1120 is positioned on the outside of the instrument or device to permit coupling of an external fluid line to an internal fluid path of the device or instrument. In use of the connector 1120, a fluid line present in a component, e.g., similar to one shown in FIG. 7A can be fluidically coupled to the internal fluid path by inserting the component into the connector 1120 until resistance is encountered. The lever 1122 can then be rotated circumferentially to cause the connector 1120 to couple to the component. Once the lever is locked into place (or rotated to its desired position), the external fluid line will be fluidically coupled to an internal fluid path of the device or instrument through a substantially fluid tight seal between the external fluid line and the connector 1120.

In some embodiments, the connectors described herein can be integral to a component or device of a chromatography system. For example, the connector may be an integral part of an injector configured to receive a sample. Referring to FIG. 12, an injector assembly is shown comprising an inlet 1210 configured to receive a sample and provide at least some portion of the received sample to a first fluid line 1220 within a housing 1205. The fluid line 1220 is fluidically coupled to a connector as described herein. For example, the fluid line 1220 can be fluidically coupled to a connector 1230 at a first end of the connector 1230 through a coupler 1225, e.g., a threaded coupler. A separate fluid line 1250 can be fluidically coupled to the injector inlet 1210 using the second end of the connector 1230 as described herein. For example, the connector 1230 may comprise internal locking features configured to provide an axial force in a first position and release the axial force upon movement of the locking features from the first position to a second position. The internal locking member and/or internal locking features of the connector can be configured to couple a component comprising the separate fluid line in the first position of the internal locking member to retain the separate fluid line 1250 within a channel of the connector and to fluidically couple the separate fluid line 1250 to the injector inlet. The internal connector 1230 can be configured to provide a substantially fluid tight seal between the component comprising the separate fluid line 1250 and the connector 1230 in the first position of the internal locking member. This connection can permit fluid to be provided to a detector 1260 fluidically coupled to the separate fluid line 1250.

In certain examples, the connector 1230 may be configured similar to any of the connectors described herein. For example, the connector 1230 may comprise an internal locking ball or balls which can apply an axial force to an inserted component and retain that inserted component through an interference fit. In other configurations, the connector 1230 further comprises a pair of internal locking balls positioned between the locking collar and the first end of the connector 1230, e.g., the end near the coupler 1225. In some examples, the pair of locking balls are configured to move radially outward when the locking collar is rotated circumferentially from the first position to the second position to permit insertion of the component (e.g., a body similar to that of FIG. 7A, for example) comprising the separate fluid line 1250 into the locking collar and are configured to move radially inward when the locking collar is rotated circumferentially from the second position to the first position to engage outer surfaces of the component comprising the first fluid line to retain the component comprising the separate fluid line to the connector 1230 through an interference fit between the pair of locking balls and the inserted component. In some embodiments, the locking collar is configured to rotate circumferentially even further to move the locking collar to a third position configured to provide a longitudinal force toward the first end of the connector 1230 to retain the component comprising the separate fluid line 1250 to the connector 1230 and provide a substantially fluid tight seal between the component comprising the separate fluid line 1250 and the connector 1230. In certain examples, the third position of the locking collar is configured to provide the longitudinal force against a plurality of disc springs positioned between the locking collar and the first end of the connector 1230, the plurality of disc springs configured to maintain the substantially fluid tight seal with temperature changes. In some instances, each of the disc springs comprises a nickel chromium alloy. In other instances, the connector 1230 may further comprises a column lock housing (e.g., a second end of the connector 1230) configured to receive the first spring, a lock ball cage configured to couple to the column lock housing, the lock ball cage configured to receive the pair of locking balls, and a spacer configured to couple to the lock ball cage and the locking collar, in which the spacer is further configured to spatially position one or more rotating balls In certain configurations, the connector 1230 further comprises a rotator lever configured to couple to the locking collar. In some embodiments, the connector 1230 further comprises at least one rotating ball configured to facilitate coupling of the component to the connector 1230. In some examples, the connector 1230 further comprises a ball retainer ring configured to retain the rotating ball in the connector 1230. In some instances, the connector 1230 comprises threads at the first end to couple the injector inlet to the connector 1230.

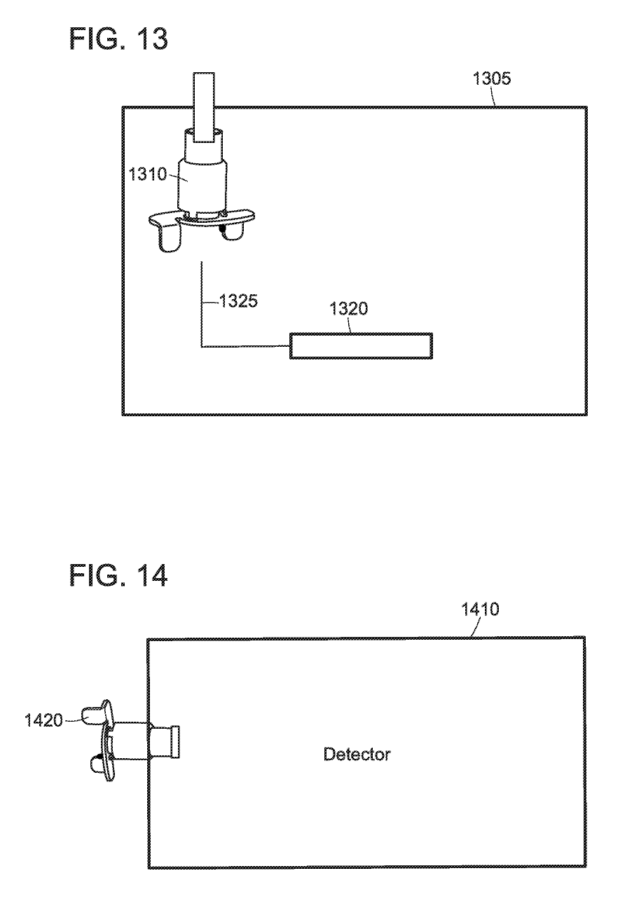

In some configurations, while the connector 1230 is shown as being coupled to the inlet 1210 through a fluid line 1220, if desired, the fluid line 1220 can be omitted and the connector 1230 and inlet 1210 may form an integral injector. Referring to FIG. 13, an injector comprising an integral connector 1310 is shown. The integral connector 1310 is configured to fluidically couple to a separate fluid line 1325, which itself is fluidically coupled to a chromatography column. The integral connector 1310 may comprise an internal locking member and/or internal locking features configured to provide an axial force in a first position and release the axial force upon circumferential rotation of the locking member from the first position to a second position. The integral connector 1310 comprises a first end, a second end and a channel between the first end and the second end. The first end is fluidically coupled to the inlet of the injector and the second end is configured to fluidically couple to the separate fluid line 1325. The internal locking member of the integral connector 1310 is configured to couple the connector 1310 to a component comprising the separate fluid line 1325 in the first position of the internal locking member to retain the separate fluid line 1325 within the channel of the integral connector 1310 and to fluidically couple the separate fluid line 1325 to the injector inlet. The internal locking member is configured to provide a substantially fluid tight seal between the component comprising the separate fluid line 1325 and the injector comprising the integral connector 1310 in the first position of the internal locking member, e.g., by placing one or more locking balls in a suitable position to provide an axial force to the component and retain the component through an interference fit between the component and the one or more locking balls.

In certain instances, the connector 1310 further comprises a first spring configured to provide a longitudinal force to the internal locking member to bias the internal locking member away from the first end of the connector 1310 in the second position of the internal locking member. In other instances, the internal locking member is configured as a locking collar that is configured to rotate circumferentially between the first position and the second position. In some embodiments, the connector 1310 further comprises a pair of internal locking balls positioned between the locking collar and the first end of the connector 1310. In some examples, the pair of locking balls are configured to move radially outward when the locking collar is rotated circumferentially from the first position to the second position to permit insertion of the component comprising the separate fluid line 1325 into the locking collar and are configured to move radially inward when the locking collar is rotated circumferentially from the second position to the first position to engage outer surfaces of the component comprising the separate fluid line 1325 to retain the component comprising the separate fluid line to the connector 1310. In certain examples, the locking collar is configured to rotate circumferentially even further to move the locking collar to a third position configured to provide a longitudinal force toward the first end of the connector to retain the component comprising the separate fluid line 1325 to the connector 1310 and provide a substantially fluid tight seal between the component comprising the separate fluid line 1325 and the connector 1310. In some embodiments, the third position of the locking collar is configured to provide the longitudinal force against a plurality of disc springs positioned between the locking collar and the first end of the connector 1310, the plurality of disc springs configured to maintain the substantially fluid tight seal with temperature changes. In some examples, each of the disc springs comprises a nickel chromium alloy.

In further embodiments, the connector 1310 further comprises a column lock housing configured to receive the first spring, a lock ball cage configured to couple to the column lock housing (e.g., a second end of the connector 1310), the lock ball cage configured to receive the pair of locking balls, and a spacer configured to spatially position at least one rotating ball. In certain instances, the connector 1310 further comprises a rotator lever configured to couple to the locking collar. In some examples, the connector 1310 further comprises at least one rotating ball configured to facilitate insertion of the component comprising the separate fluid line 1325 into the connector 1310. In certain embodiments, the connector 1310 further comprises a ball retainer ring configured to retain the rotating ball in the connector 1310. In some instances, the connector 1310 further comprises a retainer clip configured to couple to the rotating lever to couple the rotating lever to the locking member. In some embodiments, a first end of the connector 1310 comprises a smaller outer diameter than an outer diameter of the second end of the connector 1310.

In certain configurations, a detector may comprise an integral coupler. Referring to FIG. 14, a detector 1410 is shown that comprises a coupler 1420. A portion of the coupler 1410 can be present outside of the detector 1410 to permit coupling of a fluid line to the detector 1410. For example, the connector 1420 can be configured to fluidically couple a fluid line to the detector or fluidically coupled to a fluid line to an inlet of the detector. In some examples, the connector 1420 comprises an internal locking member and/or internal locking features configured to provide an axial force in a first position and release the axial force upon circumferential rotation of the locking member from the first position to a second position. One end of the connector 1420 may be configured to fluidically couple to an inlet of the detector 1410 (or the detector 1410 itself) and another end of the connector may be configured to fluidically couple to the separate fluid line. In some instances, the internal locking member of the connector 1420 is configured to couple the connector 1420 to a component comprising the separate fluid line in the first position of the internal locking member to retain the separate fluid line within the channel of the connector and to fluidically couple the separate fluid line to the detector 1410, e.g., one or more locking balls of the connector 1420 may couple to the component through an interference fit. The internal locking member of the connector 1420 can be configured to provide a substantially fluid tight seal between the component comprising the separate fluid line and the connector in the first position of the internal locking member. The connector 1420 may be configured as any of the connectors described herein or other similar connectors.

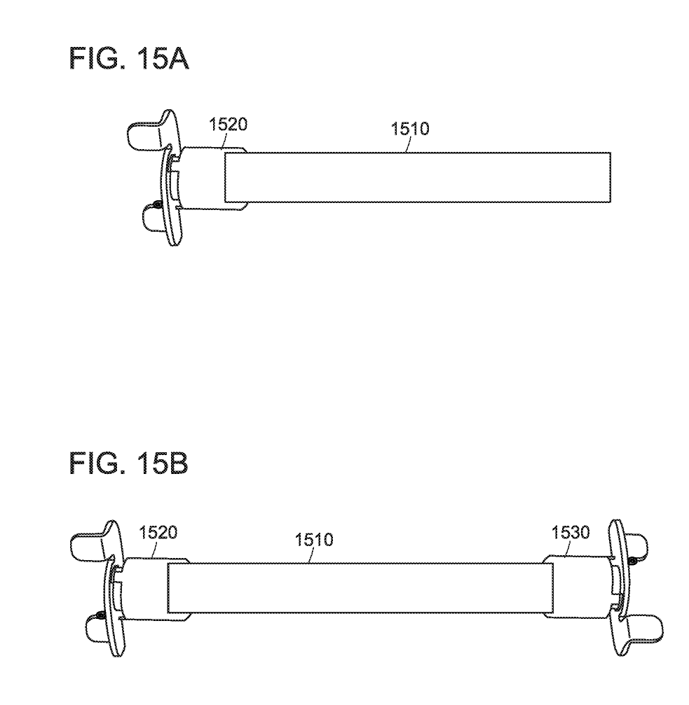

In certain examples, the connectors described herein can be used or integrated with one or more columns. For example, the connector can be present at one or both ends of a column. Illustrations are shown in FIGS. 15A and 15B. The column 1510 may comprise a connector 1520 at one end and may comprise an optional second connector 1530 at an opposite end. The connectors 1520, 1530 can be the same or they can be different. In some instances, the connector 1520 can be configured to fluidically couple a fluid line to the column 1510. In some examples, the connector 1520 comprises an internal locking member and/or internal locking features configured to provide an axial force in a first position and release the axial force upon circumferential rotation of the locking member from the first position to a second position. One end of the connector 1520 may be configured to fluidically couple to the column 1510 and another end of the connector may be configured to fluidically couple to the separate fluid line. In some instances, the internal locking member of the connector 1520 is configured to couple the connector 1520 to a component comprising the separate fluid line in the first position of the internal locking member to retain the separate fluid line within the channel of the connector 1520 and to fluidically couple the separate fluid line to the column 1510, e.g., one or more locking balls of the connector 1520 may couple to the component through an interference fit. The internal locking member of the connector 1520 can be configured to provide a substantially fluid tight seal between the component comprising the separate fluid line and the connector in the first position of the internal locking member. The connector 1530 may also be configured in a similar manner if desired. The exact nature and size of the column 1510 can vary. In some instances, the column 1510 can be configured as a capillary column comprising a stationary phase. The capillary column can be contained within the column 1510, or the entire column 1510 may be formed as a capillary column.

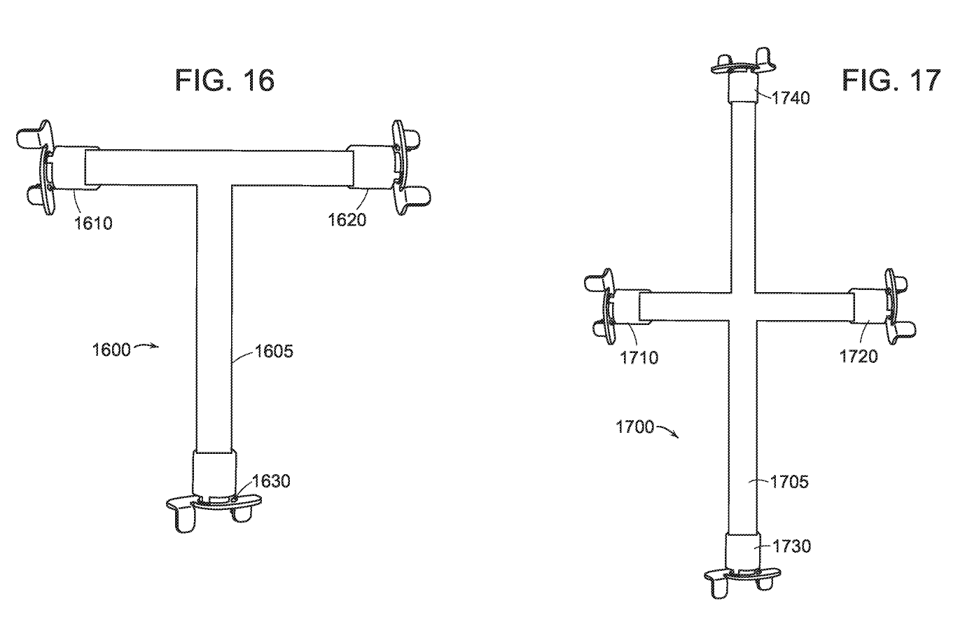

In certain embodiments, the connectors described herein can be used to provide 3-way coupling of various fluid lines. For example, the connectors can be integrated into a T-shaped device or manifold which comprises one, two, three or more connectors and optionally internal valves or other structures to permit three way coupling. In some instances, the connectors can be part of, or coupled to, a 3-way solenoid valve. Referring to FIG. 16, a T-shaped manifold comprising three separate connectors as described herein is shown. The manifold 1600 comprises connectors 1610, 1620 and 1630. A common body 1605 provides fluidic coupling between the three connectors 1610, 1620 and 1630. The connectors 1610, 1620, and 1630 can be the same or they can be different or any two of the connectors 1610, 1620 and 1630 can be the same. In some instances, the connector 1610 can be configured to fluidically couple a fluid line to the body 1605. In some examples, the connector 1610 comprises an internal locking member and/or internal locking features configured to provide an axial force in a first position and release the axial force upon circumferential rotation of the locking member from the first position to a second position. One end of the connector 1610 may be configured to fluidically couple to the body 1605 and another end of the connector may be configured to fluidically couple to the separate fluid line. In some instances, the internal locking member of the connector 1610 is configured to couple the connector 1610 to a component comprising the separate fluid line in the first position of the internal locking member to retain the separate fluid line within the channel of the connector 1610 and to fluidically couple the separate fluid line to the body 1605, e.g., one or more locking balls of the connector 1610 may couple to the component through an interference fit. The internal locking member of the connector 1610 can be configured to provide a substantially fluid tight seal between the component comprising the separate fluid line and the connector in the first position of the internal locking member. The connectors 1620, 1630 may also be configured in a similar manner if desired, though the different connectors 1610, 1620 and 1630 need not be configured in the exact same manner.

In certain embodiments, the connectors described herein can be used to provide 4-way coupling of various fluid lines. For example, the connectors can be integrated into a manifold which comprises one, two, three, four or more connectors and optionally internal valves or other structures to permit three way coupling. In some instances, the connectors can be part of, or coupled to, a 3-way solenoid valve, a binary solenoid or other suitable valves positioned in various arms of the body of the connector. Referring to FIG. 17, a cross-shaped manifold comprising four separate connectors as described herein is shown. The manifold 1700 comprises connectors 1710, 1720, 1730 and 1740. A common body 1705 provides fluidic coupling between the four connectors 1710, 1720, 1730 and 1730. The connectors 1710, 1720, 1730 and 1740 can be the same or they can be different or any two or three of the connectors 1710, 1720, 1730 and 1740 can be the same. In some instances, the connector 1710 can be configured to fluidically couple a fluid line to the body 1705. In some examples, the connector 1710 comprises an internal locking member and/or internal locking features configured to provide an axial force in a first position and release the axial force upon circumferential rotation of the locking member from the first position to a second position. One end of the connector 1710 may be configured to fluidically couple to the body 1705 and another end of the connector may be configured to fluidically couple to the separate fluid line (not shown). In some instances, the internal locking member of the connector 1710 is configured to couple the connector 1710 to a component comprising the separate fluid line in the first position of the internal locking member to retain the separate fluid line within the channel of the connector 1710 and to fluidically couple the separate fluid line to the body 1705, e.g., one or more locking balls of the connector 1710 may couple to the component through an interference fit. The internal locking member of the connector 1710 can be configured to provide a substantially fluid tight seal between the component comprising the separate fluid line and the connector in the first position of the internal locking member. The connectors 1720, 1730 and 1740 may also be configured in a similar manner if desired, though the different connectors 1710, 1720, 1730 and 1740 need not be configured in the exact same manner. In some instances two of the connectors 1710, 1720, 1730 and 1740 are the same, or three of the connectors 1710, 1720, 1730 and 1740 are the same or all of the connectors 1710, 1720, 1730, and 1740 are the same.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A connector assembly configured to fluidically couple two or more separate fluid lines to each other, the connector assembly comprising:
a first body comprising an internal locking member configured to rotate circumferentially between a first position and a second position, the first body comprising a first end, a second end and a channel between the first end and the second end, the first end configured to fluidically couple to a first fluid line; and
a second body configured to couple to the internal locking member of the first body, the second body comprising a first end and a second end opposite the first end, the second body comprising an internal channel between the first end and the second end, the internal channel of the second body configured to receive a second fluid line and retain a selected length of the second fluid line in a fixed position outside of the first end of the second body, wherein the internal locking member of the first body is configured to couple the first body to the second body in the first position of the internal locking member to retain the second fluid line within the channel of the first body and to fluidically couple the first fluid line to the second fluid line, in which the internal locking member is configured to provide a substantially fluid tight seal between the second body and the first body in the first position of the internal locking member.

2. The connector assembly of claim 1, in which the second body comprises an opening configured to expose a longitudinal section of the second fluid line when the second fluid line is inserted into the internal channel of the second body.

3. The connector assembly of claim 2, in which an outer diameter of the second body at the opening is larger than an outer diameter of the second body not at the opening.

4. The connector assembly of claim 3, in which the opening is sized and arranged to receive a removable retention device configured to engage the exposed section of the second fluid line in a first position of the retention device to retain the second fluid line in a fixed position within the second body.

5. The connector assembly of claim 1, in which the first body further comprises a first spring configured to provide a longitudinal force to the internal locking member to bias the internal locking member away from the first end of the first body in the second position of the internal locking member.

6. The connector assembly of claim 5, in which the internal locking member is configured as a locking collar that is configured to rotate circumferentially between the first position and the second position, in which the locking collar is further configured to move longitudinally toward the first end of the first body upon rotation from the second position to the first position.

7. The connector assembly of claim 6, in which the first body further comprises a pair of internal locking balls positioned between the locking collar and the first end of the first body.

8. The connector assembly of claim 7, in which the pair of locking balls are configured to move radially outward when the locking collar is rotated circumferentially from the first position to the second position to permit insertion of the second body into the locking collar and are configured to move radially inward when the locking collar is rotated circumferentially from the second position to the first position to engage outer surfaces of the second body and retain the second body to the first body through an interference fit between the locking balls and the second body.

9. The connector assembly of claim 8, in which the locking collar is configured to rotate circumferentially to move the locking collar to a third position configured to provide a longitudinal force toward the first end of the first body to retain the second body to the first body and provide a substantially fluid tight seal between the second body and the first body.

10. The connector assembly of claim 9, in which the third position of the locking collar is configured to provide the longitudinal force against a plurality of disc springs positioned between the locking collar and the first end of the first body, the plurality of disc springs configured to maintain the substantially fluid tight seal with temperature changes.

11. The connector assembly of claim 10, in which each of the disc springs comprises a nickel chromium alloy.

12. The connector assembly of claim 11, in which the first end of the second body is configured to receive a fitting sized and arranged to receive the second fluid line through an opening in the fitting.

13. The connector assembly of claim 11, in which the first body further comprises:
a column lock housing;
a lock ball cage configured to couple to the column lock housing, the lock ball cage configured to receive the pair of locking balls; and
a spacer configured to couple to the lock ball cage and the locking collar, in which the spacer is further configured to spatially position at least one rotating ball within the first body.

14. The connector assembly of claim 13, in which the first body further comprises a retainer clip configured to couple to the second body and retain the first body to the second body prior to movement of the locking collar from the second position to the first position.

15. The connector assembly of claim 13, in which the first body further comprises a rotator lever configured to couple to the locking collar.

16. The connector assembly of claim 15, in which the first body further comprises three rotating balls configured to facilitate rotation of the locking collar.

17. The connector assembly of claim 16, in which the first body further comprises a ball retainer ring configured to retain the rotating balls in the first body.

18. The connector assembly of claim 17, in which the first body further comprises a retainer clip configured to couple the rotator lever to the locking collar.

19. The connector assembly of claim 1, in which the first end of the second body is separable from the second end of the second body, and in which the first end of the second body comprises a material that can receive an axial force from the first body to retain the second body to the first body without any substantial deformation of the first end of the second body.

20. The connector assembly of claim 19, in which the first end of the second body comprises hardened steel or a nickel chromium alloy, and in which the internal locking member is configured to rotate circumferentially about ninety degrees from the second position to the first position.

21-105. (canceled)
